(19) United States
(12) Patent Application Publication
(10) Pub. No.: US 2005/0168323 A1
(43) Pub. Date: Aug. 4, 2005

(54) Security modules for conditional access with restrictions

(75) Inventors: Petrus Johannes Lenoir, Eindhoven (NL); Sebastiaan Antonius Fransiscus Arnoldus Van Den Heuvel, Eindhoven (NL); Gerardus Cornelis Petrus Lokhoff, Eindhoven (NL); Hans De Jong, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., NL-5621 BA Eindhoven (NL)

(21) Appl. No.: 10/512,120

(22) PCT Filed: Apr. 22, 2003
(86) PCT No.: PCT/IB03/01668

(30) Foreign Application Priority Data
Apr. 26, 2002 (EP) 02009651.7

(51) Int. Cl. H04N 5/00

(52) U.S. Cl. 340/5.74; 713/201; 725/25

(57) ABSTRACT

A system (100) comprising a plurality of interconnected devices (101-105) and being arranged to provide the devices (101-105) conditional access to protected content items, characterized in that the system (100) is arranged to restrict the number of simultaneous sessions involving said protected content items to a predetermined total limit. Preferably the system (100) restricts the number of content items that can be accessed simultaneously to the predetermined limit. Security modules (300) such as smart cards can be used for this purpose. Each security module (300) may be arranged to restrict the number of content items to which it provides access simultaneously to an individual limit which can change over time. The system restricts the sum of the individual limits to the predetermined total limit. If the limit is reached, further sessions may he refused or allowed at reduced quality level.

The invention relates to a system comprising a plurality of interconnected devices and being arranged to provide the devices conditional access to protected content items.

In recent years, the amount of content protection systems has been growing in a rapid pace. Some of these systems only protect the content against illegal copying, while others are also prohibiting the user to get access to the content. The first category is called Copy Protection (CP) systems. CP systems have traditionally been the main focus for consumer electronics (CE) devices, as this type of content protection is thought to be cheaply implemented and does not need bidirectional interaction with the content provider. Some examples are the Content Scrambling System (CSS), the protection system of DVD ROM discs and DTCP, the protection system for IEEE 1394 connections.

The second category is known under several names. In the broadcast world, systems of this category are generally known as conditional access (CA) systems, while in the Internet world they are generally known as Digital Rights Management (DRM) systems.

Some type of CP systems can also provide services to interfacing CA or DRM systems. Examples are the systems currently under development by the DVB-CPT subgroup and the TV-Anytime RMP group. The goal is a system in which a set of devices can authenticate each other through a bi-directional connection. Based on this authentication, the devices will trust each other and this will enable/allow them to exchange protected content. The accompanying licenses describe which rights the user has and what operations he is allowed to perform on the content. The license is protected by means of some general network secret, which is only exchanged between the devices within a certain household. This network of devices is called Authorized Domain (AD).

In some of the current proposals for authorized domains, the number of devices is the main limitation of the size of the authorized domain. The proposals (like the SmartRight system developed by Thomson Multimedia) have a fixed maximum of the number of devices that might be part of the authorized domain. The main reason for limiting the size of the domain is to prevent domains from spreading unbounded over the Internet, where people open their authorized domain for complete strangers at the other end of the world. By limiting the size of the authorized domain, people have the incentive to allow only their own devices to be part of the domain.

This fixed maximum on the number of devices in the authorized domain has a number of disadvantages. One disadvantage is the fact that when a device breaks down or gets stolen, it is difficult to recover the rights associated with this device in the authorized domain, because the admission of devices to the domain may not be centrally controlled and it is also not archived which particular devices are part of the domain at any time.

A further disadvantage of the fixed maximum is the fact that it is very difficult to determine beforehand what a reasonable value of the maximum is. Especially when in the future more networked devices are hooked up to the home network; the values that seem reasonable today may be far too low in the future. However, it is very complex to implement such a fixed maximum in a way that allows easy upgrading of the maximum in the future.

It is an object of the present invention to provide a system in which the size of a particular domain can be restricted, whilst overcoming the disadvantages associated with a fixed maximum on the number of the devices in the particular domain.

This object is achieved according to the present invention in a system which is characterized in that it is arranged to restrict the number of simultaneous sessions involving said protected content items to a predetermined total limit. This way the number of simultaneously active sessions is used as a measure or indication of the domain size. This number could be, for example, the number of content items accessed at the same time, or the number of activated rendering devices. The number of devices in the system is unrestricted, although not all may be able to operate unrestrictedly at the same time.

Preferably the number of content items that can be accessed simultaneously is restricted to the predetermined limit. To this end a security module such as a smart card can be used. Newly added security modules should then report the number of simultaneous accesses to content it is arranged to provide, and the system can then decide whether to authenticate the new security module, or decide to restrict the number of simultaneous accesses it may provide.

One could for example use as security module a smart card that supports only one session (i.e. with the device that holds the smart card) and the total number of smart cards permitted to be used in the domain at one time is limited to a certain maximum.

In another embodiment, devices need to register themselves at the authorized domain in the normal way, but the total number of devices that can register is unlimited. On top of this registration, a device needs to open a session to a security module, such as a smartcard. The total limitation of the network size is in this embodiment accomplished by limiting the number of security modules in cooperation with limiting the number of sessions that a security module supports.

If the system comprises a plurality of security modules, each security module could be arranged to restrict the number of content items to which it provides access simultaneously to an individual limit, which can change over time. The system then restricts the sum of the individual limits to the predetermined total limit. For example, one security module may be arranged to increase its individual limit in response to another security module decreasing its individual limit.

In another embodiment the system is arranged to restrict the number of devices that are active simultaneously to the predetermined total limit. In yet another embodiment the system is arranged to restrict the number of simultaneous accesses to content of a first type to a first predetermined total limit, and the number of simultaneous accesses to content of a second type to a second predetermined total limit. For example, the first type may comprise pay-per-view content and the second type may comprise free-to-air content. This increases the flexibility of the system.

To determine whether the predetermined total limit has been reached, the system can calculate the limit in a weighted fashion, in which sessions of different types are assigned different weights.

In an embodiment the system is arranged to restrict the number of simultaneous sessions of a first type to a first predetermined total limit and the number of simultaneous sessions of a second type to a second predetermined total limit.

In an embodiment the system is arranged to refuse a session if allowing said session would cause the number of simultaneous sessions to exceed the predetermined total limit. Alternatively the system is arranged to allow a session at a reduced quality level if allowing said session would cause the number of simultaneous sessions to exceed the predetermined total limit, or to reduce a quality level of all simultaneous sessions. This might be acceptable for a short time, and so it becomes possible for users to occasionally view “too many” sessions at the same time.

At the same time, this embodiment discourages the forming of CP domains that overlap households. If such a domain were formed, it would mean that one's favorite soccer match was suddenly reduced in quality, or that the audio commentary suddenly stopped, because the neighbors decided to watch a movie and leave the radio on.

An important additional option is to prevent “session-hopping”. ‘Session-hopping’ is a possible mechanism to share sessions over the Internet. People who have spare (unused) sessions in their own domain, might want to share those sessions over the Internet, thereby escaping from the basic requirement set on authorized domains, i.e. limiting the distribution of content over the Internet. This issue can be addressed by installing mechanisms as allowing a device to be registered at only one authorized domain and installing time delays that limit changing the registration to for instance once per day. This could be replaced with or combined with requiring an active action of the domain holder, possibly a physical action on one of the domain devices.

These and other aspects of the invention will be apparent from and elucidated with reference to the illustrative embodiments shown in the drawings, in which:

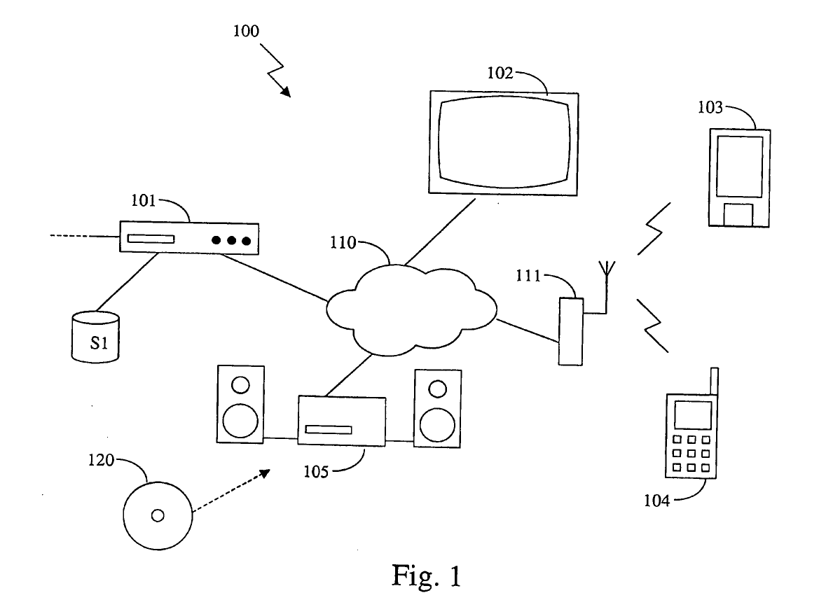

FIG. 1 schematically shows a system comprising devices interconnected via a network;

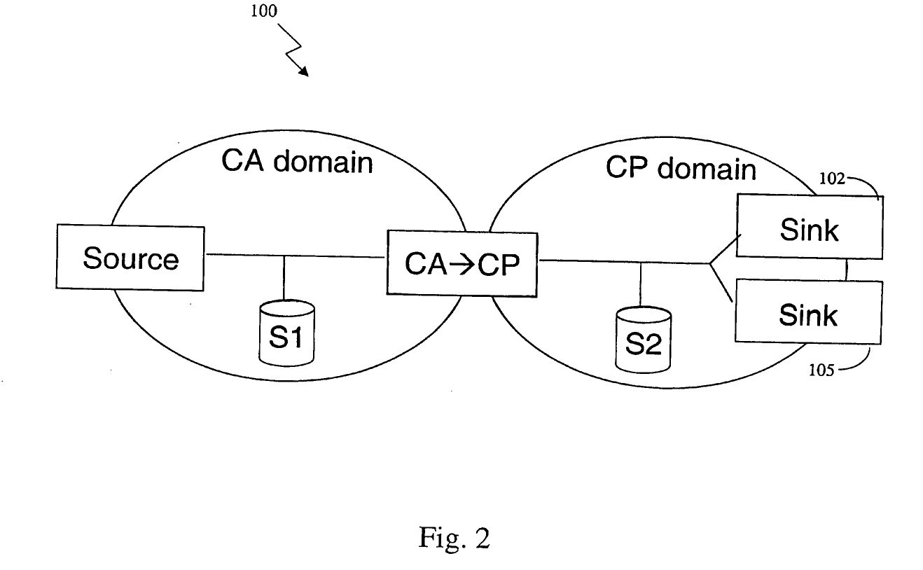

FIG. 2 schematically shows the schematic division of the system 100 of FIG. 1 into a CA domain and a CP domain; and

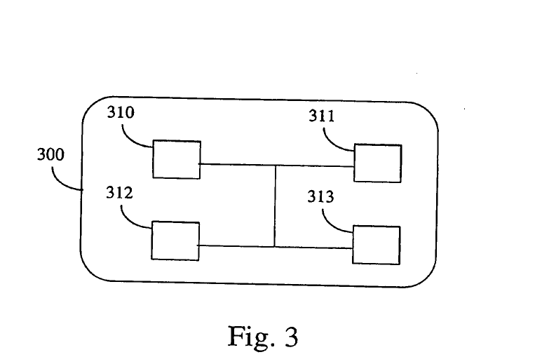

FIG. 3 schematically shows a preferred embodiment of a security module, in the form of a smart card, for use in the system of FIG. 1.

Throughout the figures, same reference numerals indicate similar or corresponding features. Some of the features indicated in the drawings are typically implemented in software, and as such represent software entities, such as software modules or objects.

FIG. 1 schematically shows a system 100 comprising devices 101-105 interconnected via a network 110. In this embodiment, the system 100 is an in-home network. A typical digital home network includes a number of devices, e.g. a radio receiver, a tuner/decoder, a CD player, a pair of speakers, a television, a VCR, a tape deck, and so on. These devices are usually interconnected to allow one device, e.g. the television, to control another, e.g. the VCR. One device, such as e.g. the tuner/decoder or a set top box (STB), is usually the central device, providing central control over the others.

Content, which typically comprises things like music, songs, movies, TV programs, pictures, books and the likes, but which also includes interactive services, is received through a residential gateway or set top box 101. The source could be a connection to a broadband cable network, an Internet connection, a satellite downlink and so on. The content can then be transferred over the network 110 to a sink for rendering. A sink can be, for instance, the television display 102, the portable display device 103, the mobile phone 104 and/or the audio playback device 105.

The exact way in which a content item is rendered depends on the type of device and the type of content. For instance, in a radio receiver, rendering comprises generating audio signals and feeding them to loudspeakers. For a television receiver, rendering generally comprises generating audio and video signals and feeding those to a display screen and loudspeakers. For other types of content a similar appropriate action must be taken. Rendering may also include operations such as decrypting or descrambling a received signal, synchronizing audio and video signals and so on.

The set top box 101, or any other device in the system 100, may comprise a storage medium S1 such as a suitably large hard disk, allowing the recording and later playback of received content. The storage medium S1 could be a Personal Digital Recorder (PDR) of some kind, for example a DVD+RW recorder, to which the set top box 101 is connected. Content can also be enter the system 100 stored on a carrier 120 such as a Compact Disc (CD) or Digital Versatile Disc (DVD).

The portable display device 103 and the mobile phone 104 are connected wirelessly to the network 110 using a base station 111, for example using Bluetooth or IEEE 802.11b. The other devices are connected using a conventional wired connection. To allow the devices 101-105 to interact, several interoperability standards are available, which allow different devices to exchange messages and information and to control each other. One well-known standard is the Home Audio/Video Interoperability (HAVi) standard, version 1.0 of which was published in January 2000, and which is available on the Internet at the address http://www.havi.org/. Other well-known standards are the domestic digital bus (D2B) standard, a communications protocol described in IEC 1030 and Universal Plug and Play (http://www.upnp.org).

It is often important to ensure that the devices 101-105 in the home network do not make unauthorized copies of the content. To do this, a security framework, typically referred to as a Digital Rights Management (DRM) system is necessary.

In one such framework, the home network is divided conceptually in a conditional access (CA) domain and a copy protection (CP) domain. Typically, the sink is located in the CP domain. This ensures that when content is provided to the sink, no unauthorized copies of the content can be made because of the copy protection scheme in place in the CP domain. Devices in the CP domain may comprise a storage medium to make temporary copies, but such copies may not be exported from the CP domain. This framework is described in European patent application 01204668.6 (attorney docket PHNL010880) by the same applicant as the present application.

Regardless of the specific approach chosen, all devices in the in-home network that implement the security framework do so in accordance with the implementation requirements. Using this framework, these devices can authenticate each other and distribute content securely. Access to the content is managed by the security system. This prevents the unprotected content from leaking to unauthorized devices and data originating from untrusted devices from entering the system.

FIG. 2 schematically shows the schematic division of the system 100 of FIG. 1 into a CA domain and a CP domain. In FIG. 2, the system 100 comprises a source, a sink, and two storage media S1 and S2. Most content enters the in-home network in the CA domain through the set-top box 101 (the source). Typically, the sinks, for instance the television system 102 and the audio playback device 105, are located in the CP domain. This ensures that when content is provided to the sink, no unauthorized copies of the content can be made because of the copy protection scheme in place in the CP domain.

A CA→CP gateway is provided between the CA and the CP domains. This gateway is responsible for letting content enter the CP domain. This process may require transcoding and/or (re-)encrypting the content, translating digital rights associated with the content to a format supported in the CP domain, and so on.

The CP domain comprises a storage medium S2, on which (temporary) copies of the content can be stored in accordance with the copy protection rules. These copies can be used for time-shifted playback of the content, but these copies may not be exported from the CP domain.

A device becomes part of the CP domain by connecting it to another device already in the CP domain, or by connecting it to the bus connecting these devices. Once a device has been added, it must remain in that particular CP domain for a certain period of time, for example one day.

FIG. 3 schematically shows a preferred embodiment of a security module, shown here in the form of a smart card 300. To protect content against unauthorized copying, instances of content are provided to the system 100 in encrypted form. Before it can be rendered it needs to be decrypted, using a control word. Handling control words and/or decrypting instances of content is the responsibility of the security module. The security module should therefore be well protected against tampering.

Of course there are many ways to implement security modules. A common secure solution is to embody the security module in the form of a smart card. The security module could also be provided as an integrated component of one of the devices 101-105, or as a separate device. The security module can be embodied in hardware, software or a combination thereof.

The smart card 300 comprises a conditional access module 310 and a secure storage module 311. Smart cards are much more difficult to compromise than ordinary computers or software and so offer a better way of protecting the conditional aspects of a conditional access service. One or more of the devices 101-105 is then equipped with a smart card reader, in which the user can insert the smart card 300.

The control word necessary to decrypt the content can be stored in the secure storage module 311 on the smart card 300. This way, it is very difficult for the user to obtain the control word, and so it is very difficult for him to access the content without paying for it. The smart card 300 may comprise a decryption module 312, which decrypts an instance of the content using the control word and supplies the decrypted instance to a rendering device such as television 102.

Alternatively, the smart card 300 can supply the control word to another device which then decrypts the instance. In this case, there is the risk that this other device has been tampered with in such a way that it will not simply decrypt the content, but instead store the control word or store the unencrypted content without authorization to do so. In order to prevent such a modified device from accessing the control word, the smart card 300 may employ an authentication mechanism in order to verify whether the device has been tampered with.

This authentication mechanism is for instance realized by having the smart card issue an encrypted ‘challenge’ to the device, which the device must decrypt and send back to the smart card 300. If the device cannot correctly decrypt the challenge, it is not a compliant device and may not get access to the control word. Alternatively, the smart card 300 can check the integrity of some part of the program code to be executed by the device, for example by verifying a digital signature.

The control word may be provided in an Entitlement Control Message (ECM) that is sent to the system 100 by the service provider providing the encrypted service. It could also be stored permanently in the smart card 300. This ECM is then provided to the smart card 300 and thereby to the conditional access module 310, which obtains the control word from the ECM. The control word will often be present in an encrypted form in the ECM, and so the conditional access module 310 will need to decrypt the control word first. The decryption key necessary to decrypt the control word can then be stored in the secure storage module 311.

In accordance with the present invention, the smart card 300 is also provided with a session management module 313. The term “session” refers to the handling of a specific instance of a content item, in particular decrypting the instance and supplying the decrypted instance to the rendering device. Handling may be restricted to a portion of the instance (e.g. the audio channels or the video stream of a movie), or cover the instance as a whole (audio, video, Teletext information, and so on). Another definition of a “session” could be the number of active devices, or the number of active “display” devices (e.g. TV, monitor, audio amplifier, . . . ). The smart card 300 is a central entity in this process.

It may be that two rendering devices are simultaneously rendering the same television program, or that one rendering device is playing back a piece of music and a storage device is making a copy of the same piece of music at the same time. In both cases the system 100 is handling two simultaneous sessions, even if both devices are operating on the same stream of data.

The session management module 313 is operable to restrict the number of simultaneous sessions that the smart card 300 is permitted to handle. This way, the owner of the system 100 can connect an unlimited number of devices to the system 100, but he will not be able to view or listen to many instances of content at the same time. If the entire system 100 is located within one household, this is not a problem, assuming a reasonable upper limit on the number of simultaneous sessions is chosen.

If the devices in the system 100 are distributed over various houses in a particular district, the same upper limit seriously restricts the use of the devices. For example, if the upper limit is set to twelve simultaneous sessions, all members of an average household should easily be able to view their favorite television programs, listen to the radio and at the same time record their favorite movie on another channel. However, if there are devices from five households in the system 100, an upper limit of twelve simultaneous sessions is way too low to permit everyone in these households to view and listen to their favorite content.

There are of course many ways in which the session management module 313 can restrict the number of simultaneous sessions. A straightforward implementation uses a counter which is increased every time the smart card 300 accepts a new session, and prevents the smart card 300 from accepting a new session if the counter exceeds a maximum value.

To keep track of all the sessions handled simultaneously by the smart card 300, the respective session IDs can in another embodiment be stored in a memory locations such as a table or register. By restricting the number of entries in this table, or the number of registers available, it becomes impossible to accept another session if all the entries are occupied.

This restriction can be put in place by simply providing the smart card 300 with no more memory than strictly necessary for the desired maximum number of entries or registers. The restriction can also be enforced by implementing a counter indicating the maximum number of entries that may be used at one time. This counter can then be increased or decreased at any time, which makes it easier to later modify the maximum.

Of course those skilled in the arts will easily be able to design many variations on the above, as well as many alternative ways to restrict the number of simultaneous sessions permitted by a smart card.

The maximum number of session supported by a particular smart card can be printed on the card itself. This way, it becomes very easy to market and sell different smart cards with different session handling capacities. Cards with a low maximum number could be sold at a low price, and cards with a high maximum number at a higher price. Users can then choose a card which best suits their situation.

If the smart card 300 receives a request for a session, but handing that session would exceed the maximum number of permitted simultaneous sessions, the smart card 300 should refuse to accept the session. The device requesting that session could report the refusal to the user. The interaction protocol between device and smart card could be extended with a specific message to indicate that the maximum has been reached.

Of course the system 100 may have more than one security module. For example, every set-top box 101 in the system 100 may require a separate smart card. If every smart card in the system 100 restricts the number of simultaneous sessions it supports as explained above, then the maximum number of session permitted in the system 100 is equal to the sum of the numbers permitted by the individual smart cards. This allows a great flexibility in choosing the maximum number of simultaneous sessions to be supported by the system 100.

When a new security module is added to the system 100, it must authenticate itself to at least one other security module already in the system 100. This way the system 100 ensures that all the security modules are authentic. As part of the authentication procedure, the newly added security module can report the number of simultaneous sessions it supports. This way the other security modules in the system 100 know what extra capacity is now available. This number could for instance be reported to the user, possibly along with the number of available sessions that can potentially be enabled.

It may be desirable to also define a maximum number of simultaneous sessions allowed within the system 100, regardless of the individual maxima enforced by the individual security modules. This maximum number of simultaneous sessions in the system 100 can be enforced by allowing no more than a certain number of security modules in the system at any time. The authentication for the newly added security module will then fail if this certain number of security modules is already present in the system 100.

Alternatively, the other security module might refuse to authenticate the newly added security module if the maximum number of simultaneous sessions it supports is too high. This way it is prevented that multiple households create a combined domain with their respective devices and all buy several security modules with very high capacity.

The security modules could for instance be programmed in advance with the knowledge that the system 100 may at no time support more than 64 simultaneous sessions. The user can then buy a smart card supporting 32 simultaneous sessions, and later buy another smart card supporting 16 simultaneous sessions. All this capacity can then be used in the system 100.

However, if the user subsequently buys another smart card supporting 32 simultaneous sessions, the preprogrammed upper limit of 64 simultaneous sessions is exceeded. Upon registering with the system 100, this subsequently purchased smart card then learns that it may not use more than 16 of its 32 session IDs registers, or that it should restrict the maximum value of its counter to 16. Another way of approaching this issue is to refuse to register such a card.

The security modules can redistribute unused session handling capacity between each other. When a new security module is then added to the system 100, it queries the other security modules already on the system 100 to find out whether they are all handling all the sessions they are allowed to support. If this is not the case, some of this spare capacity is then assigned to the new security module.

The security modules could also redistribute their unused session handling capacity at regular intervals, or when a new session is started. This makes the system more dynamic in terms of the number of simultaneous sessions it can support. Further, the system can now respond better to shifts in the required capacity by particular devices.

In some cases a particular security module may be able to handle sessions only for one particular rendering device. For example, a smart card inserted in a reader installed in the television 102 can typically only handle sessions for the television 102. It is not very likely that the television 102 needs many simultaneous sessions. Some of its “spare” capacity can then be assigned to another security module in the system 100.

So, if this smart card in the television 102 were to support sixteen simultaneous sessions (as in the previous example), and it needed only two, it could advertise this fact to all the other security modules in the system 100. The smart card supporting 32 simultaneous sessions could then “borrow” the spare capacity and subsequently raise its own maximum number of permitted simultaneous sessions from 16 to 30. Of course this type of redistribution could also involve multiple other security modules each “borrowing” some of the spare capacity of the smart card in the television 102.

By redistributing spare capacity between smart cards, the preprogrammed maximum of each individual smart card becomes less important. If the system 100 permits no more than 64 simultaneous sessions, it does not matter whether all the sessions are handled by a single security module or by 64 different security modules. However, if there is no central server to keep track of the maximum number of simultaneous sessions in the system 100, the security modules must work together to enforce the desired maximum.

A possible implementation of such cooperative system is when each security module holds a number of “session tokens”. This number can be different from the number of sessions it is able to support. When the number of tokens is lower than its capability, it can support more sessions but is not allowed to. When needed, security modules can distribute session tokens to other security modules. A token can be implemented in any of methods indicated above. In such system security modules may require methodes to inform the user of the number of tokens available in a specific instance of a security module.

Another way to do this is to introduce a distinction between two types of security modules: capacity masters and capacity slaves. A capacity master security module is provided with a preprogrammed maximum that indicates the number of simultaneous sessions that the system 100 is permitted to handle. A capacity slave security module can only borrow spare capacity from a capacity master security module, but can do nothing to increase the maximum number of simultaneous sessions permitted in the system 100.

A user can then buy one capacity master security module (i.e. a master smart card) that provides him with a maximum number of simultaneous sessions that suits his particular situation. If he subsequently buys devices that need their own smart cards, he can buy capacity slave smart cards, which would be available at a lower price. The total capacity of the system does not increase, though. If it turns out that the maximum enforced by the capacity master security module is too low, he can purchase another capacity master security module to increase this maximum.

Manufacturing these two types of security modules can become quite easily by simply providing every module with a register in which the maximum number of simultaneous sessions permitted in a system can be recorded. For capacity slave security modules this number is then set to zero. For capacity master security modules the number can be set to any arbitrary value. This values should then be communicated clearly to the potential purchaser, for example by printing it in large type on the front of the smart card.

The maximum number of simultaneous sessions can be chosen regardless of the types of sessions. However, a greater flexibility is achieved if multiple maxima are defined for different categories or types of sessions. For example, it is possible to make a distinction between for example pay-per-view television programs and free-to-air television programs. The system 100 could for example allow no more than three television sets to simultaneously render pay-per-view television programs, whilst allowing ten simultaneous free-to-air television programs to be rendered.

To distinguish between different types of content, preferably metadata is supplied for instances of content which indicates the type of content. This metadata could be supplied for example in a program information table such as used in MPEG-2 tnansport streams, or be provided to an Electronic Program Guide (EPG) information stream. The metadata could also be read out from a server on the Internet, or from any other source.

The metadata can also be embedded in the instance using a watermark or other steganographic technique. This way the metadata will not be lost if the instance is subsequently transcoded or becomes separated from its program information table.

The same kind of distinction can be made between classes of content, such as spoken audio, music, pictures, television programs and movies. Audio content such as radio programs may be assigned a higher maximum than audiovisual content such as movies. This makes it possible for several people to listen to the radio at the same time, without interfering with anyone's ability to watch movies on the television 102.

A session can also be counted in a weighted fashion when determining whether the maximum has been reached. For example, a radio program could be counted as 1.0, a television program as 2.0 and a movie as 2.5. With a maximum of ten simultaneous sessions, it is now possible to listen to the radio on ten devices, but to watch television programs on only five, or to watch movies on only four devices. Of course a user could also watch two television programs, record two movies and one radio transmission.

Another distinction between sessions that can be made is to distinguish on the purpose of the session. One can imagine that the number of sessions available for processing content so it can be stored on a storage device is different from the number of sessions available for rendering content.

It should be noted that the above-mentioned embodiments illustrate rather than limit the invention, and that those skilled in the art will be able to design many alternative embodiments without departing from the scope of the appended claims.

For example, rather than refusing to handle a new session if the maximum number has been reached, a new session could be handled with a low rendering quality, or the rendering quality of all sessions could be reduced.

Another way to discourage the forming of CP domains that overlap households could be to allow all devices or users with access to the domain to delete content, change settings and otherwise change the configuration of the domain It is not likely that users will want anyone in the neighborhood to erase content they recorded themselves, or to let the neighbors make changes to the configuration of their own televisions.

In a similar fashion, devices or users with access to the domain could be automatically granted access to certain privacy-sensitive information. For example, viewing and/or listening preferences could be readable by all users. One typically does not want to share this type of information with anyone in the neighborhood.

A system according to the invention could also hold the capability to stop certain sessions in order to allow a new session to be started. The system can choose one of the sessions itself (for example, the oldest running session, or a randomly chosen session), or let a user pick a session to stop. This user would preferably be the one that requested the new session. This also requires cooperation between all users of the system 100, and so discourages the expansion of the domain beyond households.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer.

In the device claim enumerating several means, several of these means can be embodied by one and the same item of hardware. The mere fact that certain measures are recited in mutually different dependent claims does not indicate that a combination of these measures cannot be used to advantage.

1. A system (100) comprising a plurality of interconnected devices (101-105) and being arranged to provide the devices (101-105) conditional access to protected content items, characterized in that the system (100) is arranged to restrict the number of simultaneous sessions involving said protected content items to a predetermined total limit.

2. The system (100) of claim 1, being arranged to restrict the number of content items that can be accessed simultaneously to the predetermined limit.

3. The system (100) of claim 2, comprising at least one security module (300) for providing the devices (101-105) the conditional access and being arranged to restrict the number of content items that can be accessed simultaneously to the predetermined limit.

4. The system (100) of claim 3, in which a new security module that is to be added to the system must authenticate itself to the system, during which authentication the new security module is arranged to report the number of simultaneous accesses to content it is arranged to provide.

5. The system (100) of claim 4, being arranged to refuse to authenticate the new security module if the reported number exceeds a predetermined individual limit.

6. The system (100) of claim 4, being arranged to indicate to the new security module a maximum number of simultaneous accesses it may provide simultaneously if the reported number exceeds a predetermined individual limit.

7. The system (100) of claim 4, being arranged to authenticate the new security module only if a sufficient period of time has elapsed since the last time the new security module was added to the system.

8. The system (100) of claim 3, comprising a plurality of security modules, each security module being arranged to restrict the number of content items to which it provides access simultaneously to an individual limit, the system being arranged to restrict the sum of the individual limits to the predetermined total limit.

9. The system (100) of claim 8, in which one security module of said plurality is arranged to increase its individual limit in response to another security module of said plurality decreasing its individual limit.

10. The system (100) of claim 9, comprising a number of capacity master security modules and a number of capacity slave security modules, a capacity slave security modules being arranged to increase its individual limit only in response to a capacity master security module decreasing its individual limit.

11. The system (100) of claim 8, being arranged to distribute a number of session tokens to the plurality of security modules, said number corresponding to the predetermined total limit, each security module being arranged to restrict the number of content items to which it provides access simultaneously to the number of session tokens distributed to that security module.

12. The system (100) of claim 2, being arranged to restrict the number of simultaneous accesses to content of a first type to a first predetermined total limit, and the number of simultaneous accesses to content of a second type to a second predetermined total limit.

13. The system (100) of claim 12, in which the first type comprises pay-per-view content and the second type comprises free-to-air content.

14. The system (100) of claim 1, being arranged to restrict the number of devices (101-105) that are active simultaneously to the predetermined total limit.

15. The system (100) of claim 1, being arranged to determine whether the predetermined total limit has been reached in a weighted fashion, in which sessions of different types are assigned different weights.

16. The system (100) of claim 1, being arranged to restrict the number of simultaneous sessions of a first type to a first predetermined total limit and the number of simultaneous sessions of a second type to a second predetermined total limit.

17. The system (100) of claim 16, in which the first type comprises a rendering of a content item and the second type comprises a recording of a content item.

18. The system (100) of claim 1, being arranged to refuse a session if allowing said session would cause the number of simultaneous sessions to exceed the predetermined total limit.

19. The system (100) of claim 1, being arranged to allow a session at a reduced quality level if allowing said session would cause the number of simultaneous sessions to exceed the predetermined total limit.

20. The system (100) of claim 19, being arranged to reduce a quality level of all simultaneous sessions.
